(19) United States
(12) Patent Application Publication
(10) Pub. No.: US 2007/0153513 A1
(43) Pub. Date: Jul. 5, 2007

(54) Signal lantern

(75) Inventor: I-Hsiung Lin, Taipei (TW)

Correspondence Address: KAMRATH & ASSOCIATES P.A., 4825 OLSON MEMORIAL HIGHWAY, SUITE 245, GOLDEN VALLEY, MN, 55422, US

(73) Assignees: I-Hsiung Lin, Taipei (TW); Tony Lin, Shulin City (TW); Yi-Kun Lin, Shulin City (TW); Yuan-Dong Ye, Shulin City (TW)

(21) Appl. No.: 11/645,953

(22) Filed: Dec. 27, 2006

(30) Foreign Application Priority Data
Jan. 3, 2006 (TW) 095200097

(51) Int. Cl. F21V 9/00

(52) U.S. Cl. 362/231

(57) ABSTRACT

A signal lantern has an emitting assembly and a handle. The emitting assembly has multiple light emitting diodes that may generate lights in different colors. The handle has a front end, side and multiple buttons. The emitting assembly is mounted on the front end of the handle has. The buttons are mounted on the side of the handle and the number and colors of the buttons correspond to the colors of the lights emitting from the emitting assembly. The signal lantern can be held and the color of light of the emitting assembly can be changed with one handle.

### BACKGROUND OF THE INVENTION

1. Field of the Invention

The present invention relates to a flashlight, and more particularity to a signal lantern that can switch colors of light with a single hand.

2. Description of Related Art

Flashlights are widely used for lighting, especially for railroad workers, the railroad works can know each other status by waving flashlights. However, the railroad workers have to face a lot of unexpected situations. The conventional flashlight can not fit the requirement of the railroad workers so that a signal lantern is invented.

With reference to FIG. 3, a conventional signal lantern in accordance with the present invention has a handle (30), an emitting assembly (40), a green button (33), a red button (31) and a switch (32).

The handle (30) has a front end and a side.

The emitting assembly (40) is mounted on the front end of the handle (30) and has a reflector (41), a light bulb (42), a green cover and a red cover. The reflector (41) is mounted on the front end of the handle (30) and has a center. The light bulb (42) is mounted on the center of the reflector (41). The green cover and the red cover are slidely mounted on the center of the reflector (41) and are able to surround the light bulb (42).

The green button (33), the red button (31) and the switch (32) are slidely mounted on the side of the handle (30). The switch (32) is able to turn on or off the light bulb (42). The green button (33) is connected to the green cover. The red button (31) is connected to the red cover.

Most railroad workers will simultaneously push the green button (33) and the red button (31) to make both of the green cover and the red cover surround the light bulb (42). When the light bulb (41) emits light, the light permeates the green cover and the red cover at the same time. The light emitting from the light bulb (41) turns into in dark red color. The railroad workers may hold the handle (30) with one hand and use other hand to push the green button (33), the red button (31) and the switch (32) to turn on or off the light bulb (41) or change color of the light. Because the railroad workers need to operate the conventional signal lantern with two hands, the previously operating way of the conventional signal lantern causes the color of light cannot be changed in time when an unexpected situation occurs such that an accident easily happens.

To overcome the shortcomings, the present invention provides a signal lantern to obviate or mitigate the aforementioned problems.

### SUMMARY OF THE INVENTION

The primary objective of the present invention is to provide a signal lantern that is able to switch colors of lights in a convenient way.

The signal lantern has an emitting assembly and a handle. The emitting assembly has multiple light emitting diodes that may generate lights in different colors. The handle has a front end, side and buttons. The emitting assembly is mounted on the front end of the handle. The buttons are mounted on the side of the handle, and the number and colors of the buttons correspond to the color lights of the emitting assembly having. When an unexpected situation occurs, the color of the light emitting from the signal lantern can be changed in a convenient way with a single hand.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a signal lantern in accordance with the present invention;

FIG. 2 is a block diagram of the signal lantern in FIG. 1; and

FIG. 3 is a perspective view of a conventional signal lantern in accordance with the prior art.

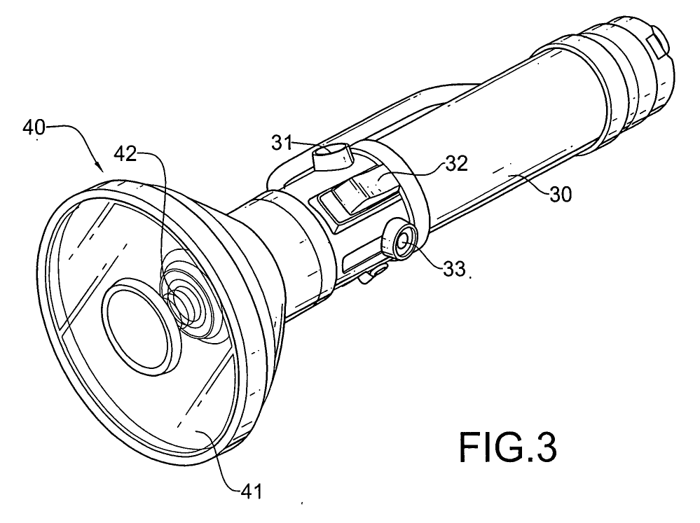

### DETAILED DESCRIPTION OF THE PREFERRED EMBODIMENT

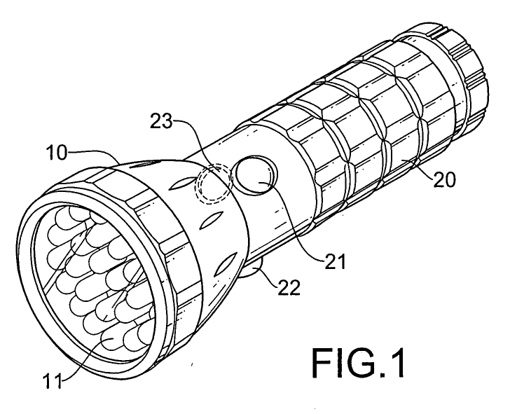

With reference to FIG. 1, a signal lantern in accordance with the present invention comprises an emitting assembly (10) and a handle (20).

The emitting assembly (10) has light emitting diodes (11)(LEDs). The LEDs (11) may generate lights in different color such as green light, red light, white light and so on. The green light is served as a safety signal, the red light is served as a dangerous signal, and the white light provides illuminating effect. Furthermore, when a situation requires light in different color, the LEDs (11) may further provide yellow light, blue light or any visible light. The LEDs (11) require small amount of electric power and may generate bright light.

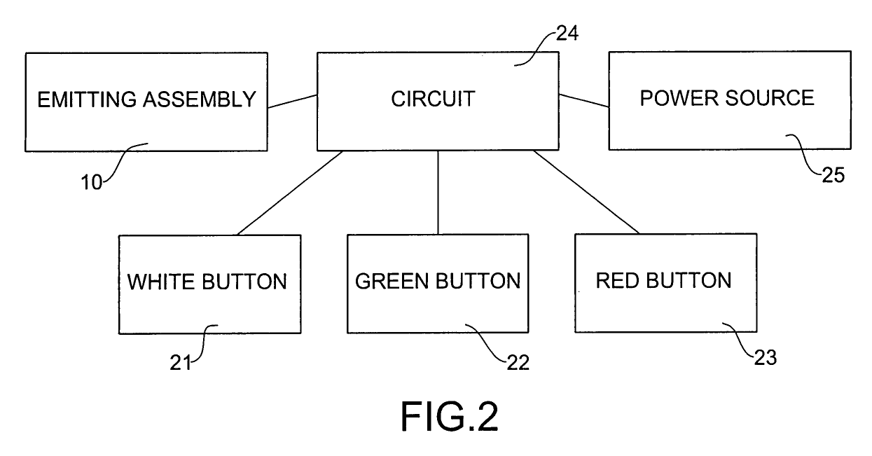

With further reference to FIG. 2, the handle (20) is hollow and has a side, a front end, a circuit (24) and a power source (25). The front end of the handle (20) holds the emitting assembly (10) inside. The handle (20) may further have buttons such as a white button (21), a green button (22) and a red button (23). The white button (21), the green button (22) and the red button (23) are mounted on the side of the handle (20) and control the white light, the green light and the whit light of the emitting assembly (10). Furthermore, the number of the buttons equates to that of the colors of light emitting from the emitting assembly (10). The buttons have different colors corresponding to the colors of lights emitting from the emitting assembly (10). The circuit (24) and the power source (25) are mounted inside of the handle (20) and connect the white button (21), the green button (22), the red button (23) and the emitting assembly (10).

A railroad worker may use one hand to hold the handle (20) and any finger from the hand may push the white button (21) to active the white light of the emitting assembly (10). If the railroad worker wants to turn off the white light of the emitting assembly (10), the railroad worker may push the white button (21) again.

When the green button (22) is pushed, the emitting assembly (10) emits the green light to notice a safety situation. If the previous described white light is not turned off but the green light is turned on, only the green light is visible.

When the red button (23) is pushed, the emitting assembly (10) emits the red light to notice a dangerous situation occurring. If the previous described white light, the green light or both are not turned off, the circuit (24) of the handle (20) will automatic turn off the white light, the green light or both when the red button (23) is pushed.

When the red light is emitted, the emitting assembly (10) can not emit the white light, the green light or both. If the railroad worker wants to have the green light and the white light, the red light has to be turned off. Because the red light is served as the dangerous signal, the purpose of that design allows the railroad worker to turn on the red light in a short time to notice or warm other people immediately.

Consequently, the railroad worker can hold the handle (20) and change the colors of lights emitting from the emitting assembly (10) with a single hand. When an unexpected situation occurs, the railroad worker can use switch the colors of lights to fit with different situations as soon as possible and keep another hand free for taking care of situations.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A signal lantern comprising
an emitting assembly having
multiple light emitting diodes for generating lights in different colors; and
a handle being hollow and having
a side;
a front end on which the light emitting diodes is mounted;
multiple buttons mounted on the side of the handle to control the light emitting diodes on or off,
wherein the handle further has a circuit and a power source mounted inside of the handle and connected to the buttons and the emitting assembly.

2. The signal lantern as claimed in claim 1, wherein the number of the buttons equate to that of colors of the lights emitting from the emitting assembly; and
each button has a color corresponding to one of the colors of the lights emitting from the emitting assembly generate.
